(19) United States
(12) Patent Application Publication
(10) Pub. No.: US 2017/0021479 A1
(43) Pub. Date: Jan. 26, 2017

(54) POSITIONING FOOT ATTACHMENT FOR A FASTENER DRIVING TOOL

(71) Applicant: Pan American Screw LLC, Conover, NC (US)

(72) Inventors: Brian Orchard, Ontario (CA); Reinhard Gotz, Zurich (CA)

(21) Appl. No.: 15/215,077

(22) Filed: Jul. 20, 2016

Related U.S. Application Data
(60) Provisional application No. 62/194,570, filed on Jul. 20, 2015.

(51) Int. Cl. B25B 23/00; E04B 1/00; E04F 15/02; B25B 21/00

(52) U.S. Cl. CPC B25B 23/005; B25B 21/002; E04B 1/003; E04F 15/02044; E04F 2015/02122

(57) ABSTRACT

A fastener driving tool and a positioning foot for the fastener driving tool are provided. The fastener driving tool includes a body having a nosepiece configured to drive a fastener along a drive axis. The positioning foot is secured to the nosepiece and includes a base having a tool-facing surface and a work piece engaging surface opposite to the tool-facing surface. The positioning foot also includes a clip attaching section at a first end of the base, the clip attaching section having a pair of notches configured to receive corresponding portions of a clip to position the clip on the base.

### BACKGROUND

The following description relates to positioning attachments, including positioning attachments for fastener driving tools, the attachments configured to position the tool relative to an object to be fastened at a desired angle.

A clip may be secured to a substrate or support to secure additional structural members to the substrate or support. For example, in decking systems, a clip may be fastened to a joist. The clip may then accommodate one or more structural members, such as deck boards, to position or hold the deck boards relative to the joist.

In known clips, such as those described in U.S. Pat. No. 8,011,153, issued to Orchard, the clip may accommodate a deck board on each side thereof, while being substantially recessed under and within respective grooves of the deck boards. Because a single clip fastened to a joist may accommodate multiple boards, the number of fastening operations to secure the deck boards to the joists may be reduced as well as the number of fasteners. Accordingly, assembly time for the deck may be reduced.

However, to secure the clip to the joist, the fastener, such as a screw, needs to be driven through the clip and into the joist at a proper angle. This requires an operator to manually align the fastener driving tool, e.g., a screw driver, with an aperture in the clip at the desired angle. In addition, the operator must then hold the tool at the desired angle while the fastener is driven through the clip and into the joist. Further still, the operator must manually position the clip relative to the joist before and while fastening the clip to the joist. This may lead to operator fatigue, be time consuming, and/or lead to inaccuracies or inconsistencies in the fastener driving process and the positioning of the clips.

Accordingly, there is a need for an attachment to a fastener driving tool to provide for quick, consistent positioning of the tool and clip relative to the work piece to drive the fastener through the clip and into the work piece at the desired angle.

### SUMMARY

According to one embodiment, there is provided a positioning foot for a fastener driving tool. The positioning foot includes a base having a tool-facing surface and a work piece engaging surface opposite to the tool-facing surface. The positioning foot also includes a clip attaching section at a first end of the base, the clip attaching section having a pair of notches configured to receive corresponding portions of a clip to position the clip on the base.

According to another embodiment, there is provided a fastener driving tool including a body having a nosepiece configured to drive a fastener along a drive axis and a positioning foot secured to the nosepiece. The positioning foot includes a base having a tool-facing surface and a work piece engaging surface opposite to the tool-facing side. The positioning foot further includes a clip attaching section at a first end of the base, the clip attaching section having a pair of notches configured to receive corresponding portions of a clip to position the clip on the base.

These and other features and advantages of the present invention will be apparent from the following detailed description, in conjunction with the appended claims.

### BRIEF DESCRIPTION OF THE DRAWINGS

FIG. 1 is a left side, top perspective view of a positioning foot for a fastener driving tool, and a portion of the fastener driving tool, according to an embodiment described herein;

FIG. 2 is a right side, top perspective view of the positioning foot and a portion of the fastener driving tool of FIG. 1;

FIG. 3 is front, top perspective view of the positioning foot and a portion of the fastener driving tool of FIG. 1;

FIG. 4 is another front, top perspective view of the positioning foot and a portion of the fastener driving tool of FIG. 1;

FIG. 5 is a rear, corner perspective view of the positioning foot and a portion of the fastener driving tool of FIG. 1;

FIG. 6 is a bottom view of a portion of the positioning foot of FIG. 1;

FIG. 7 is a left side, bottom perspective view of the positioning foot and a portion of the fastener driving tool of FIG. 1;

FIG. 8 is top, right side and rear perspective view of the positioning foot and fastener driving tool of FIG. 1 according to an embodiment described herein.

FIG. 9 is a perspective view of a clip configured for use with the positioning foot and fastener driving tool of FIGS. 1-8, according to an embodiment described herein;

FIG. 10 is a side view of the clip of FIG. 9; and

FIG. 11 is a side view of the clip of FIG. 9 positioned relative to a work piece and structural members.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

With reference generally to the figures, a positioning foot 10 for a fastener driving tool 12, according to the embodiments described herein, generally includes a base 14 having a work piece engaging surface 16 and a clip attaching section 18. The positioning foot 10 may be connected to the fastener driving tool 12, such that when positioning foot 10 is held with the work piece engaging surface 16 engaging a work piece, the fastener driving tool 12 is held at a desired angle for driving a fastener 20 into the work piece.

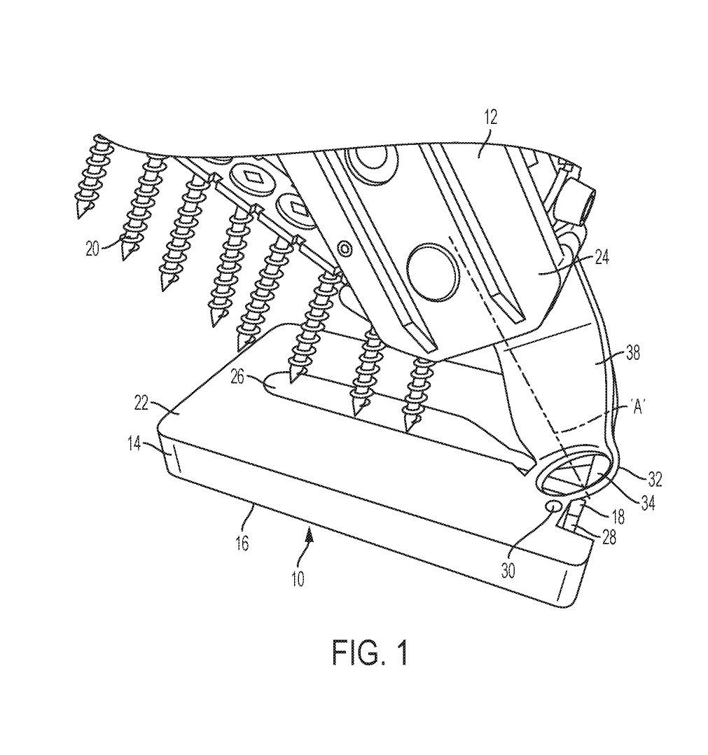

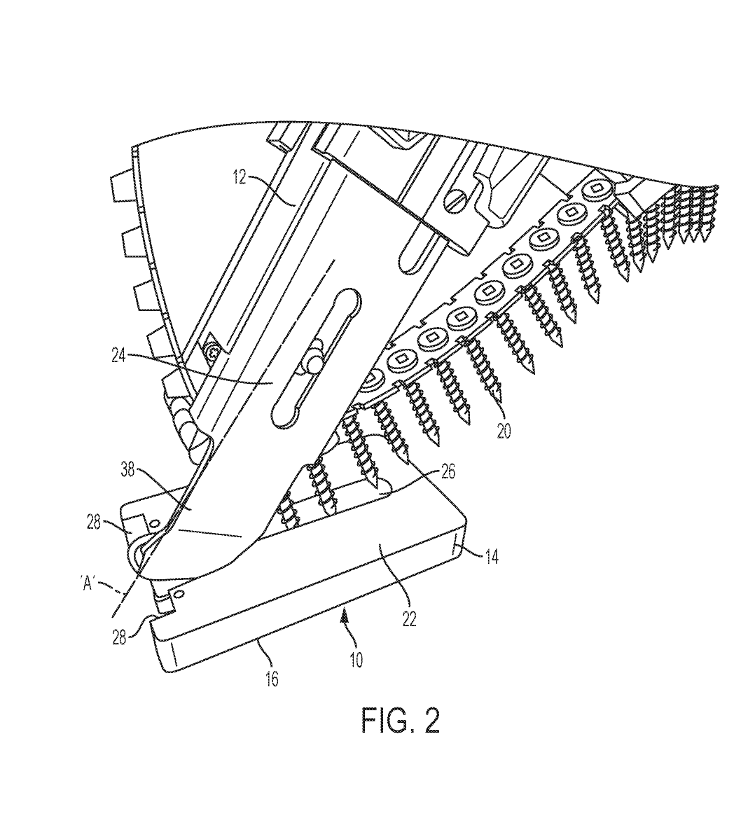

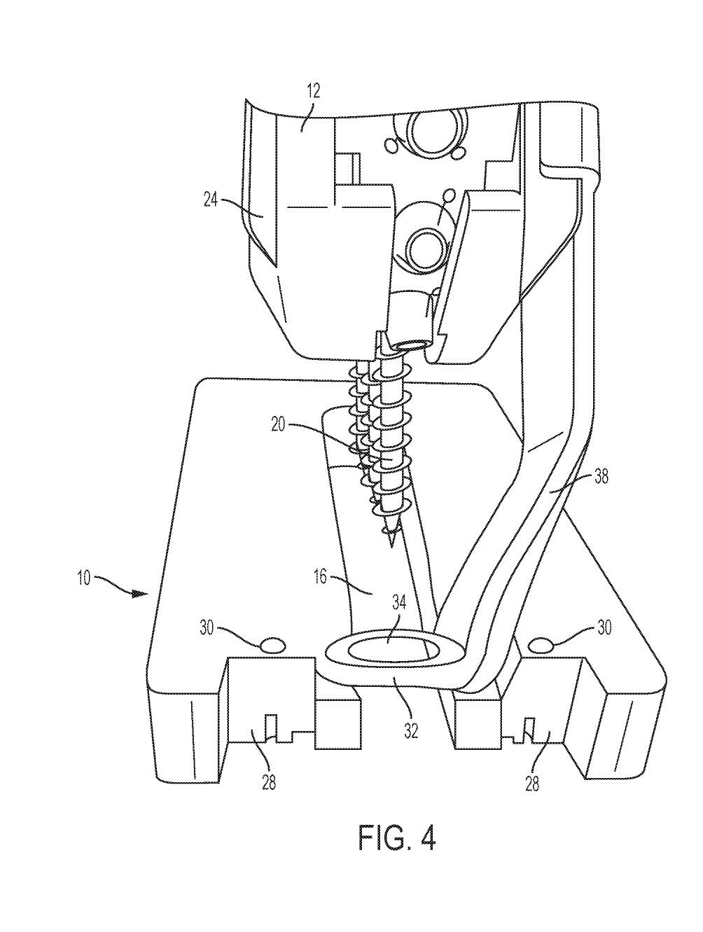

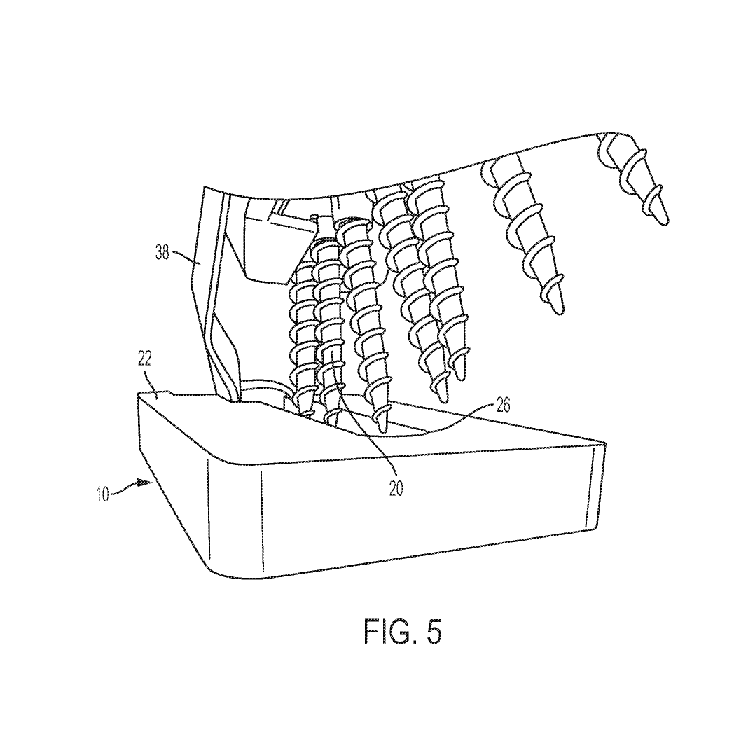

FIGS. 1-5 show different views of the positioning foot 10 and portions of a fastener driving tool 12, according to an embodiment described herein. More specifically, FIGS. 1-5 show a tool-facing surface 22, of the positioning foot 10 and portions of a nosepiece 24 of the fastener driving tool 12. Referring to FIGS. 1-5, the base 14, on the tool-facing surface 22, may include a fastener travel groove 26. The fastener travel groove 26 may be formed as a recess or slot in a surface of the base 14 and is configured to allow for sufficient clearance between the fasteners 20 and the positioning foot 10 as the fasteners 20 are loaded to a position where they may be driven into a work piece by the tool 12. In one embodiment, the tool-facing surface 22 may correspond to, or be formed on an upper, or top side of the positioning foot.

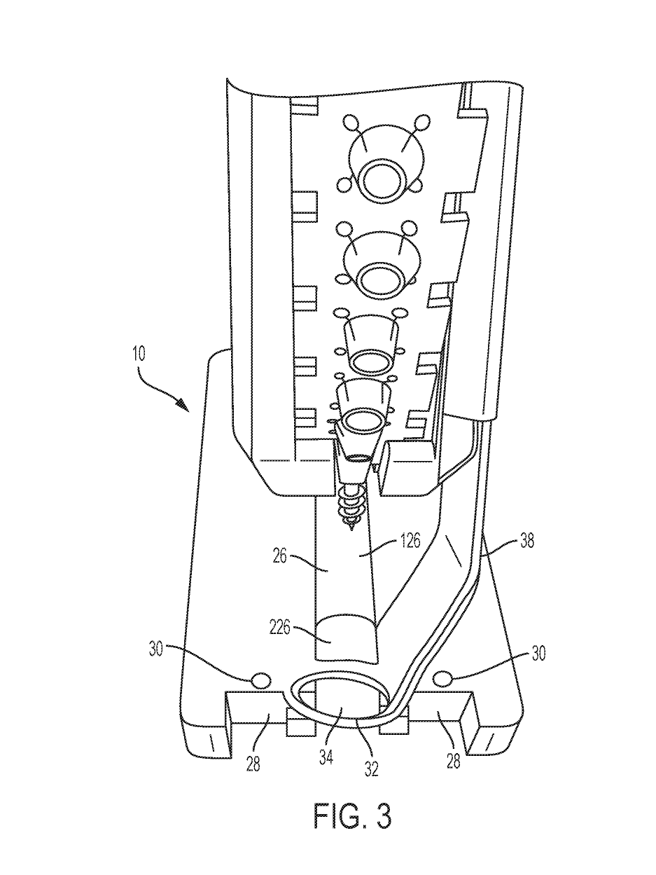

In one embodiment, the fastener travel groove 26 extends along at least a portion of a length of the base 14, and may extend to define a substantially linear path. However, it is understood that the fastener travel groove 26 may extend to define paths of other configurations as well. The fastener travel groove 26 may extend partially or completely through a thickness of the base 14. In one embodiment, as shown in FIG. 3, for example, the fastener travel groove 26 includes a first section 126 extending only partially through a thickness of the base 14, and a second section 226 extending completely through the thickness of the base 14. In addition, the fastener travel groove 26 may provide clearance for the fastener 20 to be driven into the work piece along a drive axis ‘A’ through a portion of the positioning foot 10 (see, for example, FIGS. 1, 2 and 7).

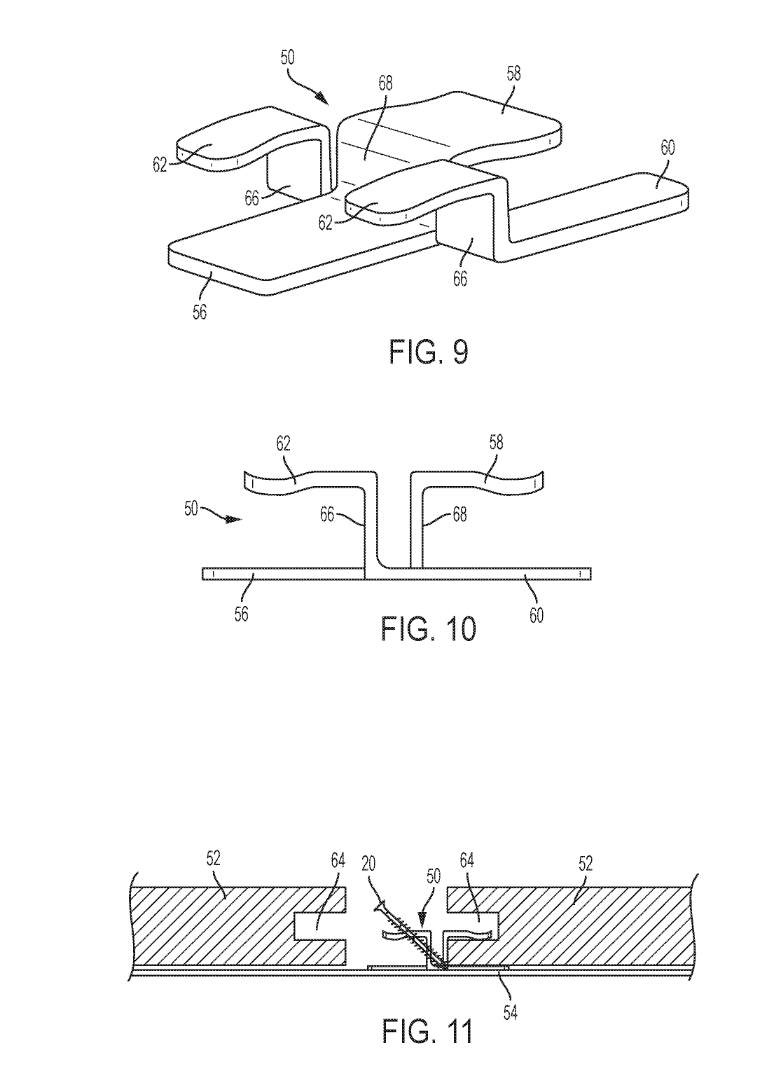

The clip attaching section 18, in one embodiment, is positioned at or near a first end, or front, of the positioning foot 10. The clip attaching section 18 is configured to receive and hold a clip 50 for fastening a structural member 52 to an underlying work piece or support member 54, as described further below with reference to FIGS. 9-11.

In one embodiment, the clip attaching section 18 includes a pair of notches 28 positioned on laterally opposite sides of the fastener travel groove 26. The clip attaching section 18 may also include one or more detents 30 configured to selectively engage and retain the clip 50 on the positioning foot 10. In one embodiment, the detent(s) 30 may be formed as spring loaded ball detents 30 outwardly biased from the base 14. For example, as best shown in FIGS. 1-4, the ball detent(s) 30 may be urged by an internally disposed spring (not shown) to project outwardly from the base 14. The one or more detents 30 may include one or more detents 30 positioned adjacent to, and associated with, each notch 28.

The positioning foot 10 may also include a guide ring 32. The guide ring 32 may be aligned with the fastener travel groove 26 in a length direction of the positioning foot 10 and includes an opening 34 through which the fastener 20 may be driven. The guide ring 32 may be substantially circular but is not limited to such a shape. The guide ring 32 is configured to receive a fastener 20 from the fastener supply that is driven by a driving element, such as a driving arm (not shown) of the tool 12. A portion of the driving element may also extend through the guide ring 32 when driving the fastener 20 into the work piece. The guide ring 32 may be substantially aligned with the driving element and a fastener receiving aperture of the clip 50. In one embodiment, the guide ring 32 may be positioned such that a central axis of the guide ring 32 corresponds to the drive axis ‘A’. That is, in one embodiment, the guide ring 32 is coaxial with the drive axis ‘A’ along which the fastener is driven for insertion into the work piece.

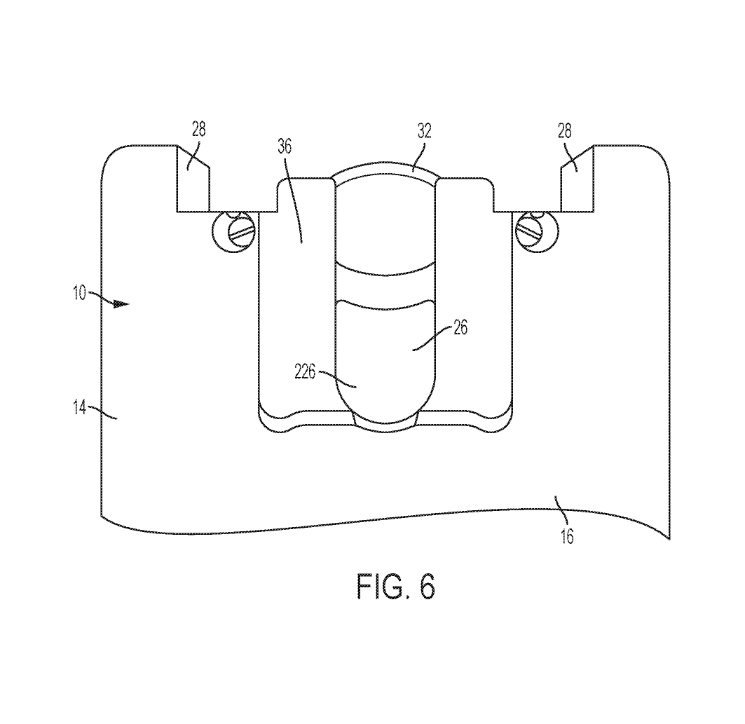

FIGS. 6 and 7 show a work piece engaging surface 16 of the base 14. In one embodiment, the work piece engaging surface 16 may correspond to, or be formed on or as a section of a bottom side of the base 14. The work piece engaging surface 16 is configured to engage the work piece to position the tool 12 at the desired angle relative to the work piece. In one embodiment, the work piece engaging surface 16 is configured to have a profile or shape that corresponds to a profile or shape of a work piece in a particular application. For example, where the work piece typically includes a substantially flat or planar surface, the work piece engaging surface 16 may be formed as, or include, a corresponding substantially flat or planar surface configured to abut against the flat or planar surface of the work piece.

The clip attaching section 18 further includes a recess 36 formed in bottom side of the positioning foot and/or the work piece engaging surface 16. The recess 36 may be formed continuously and in communication with the fastener travel groove 26, for example, by way of the second section 226 of the groove 26. Thus, the clip attaching section 18 may extend across portions of the tool-facing surface 22, bottom side or work piece engaging surface 16, and a front side of the positioning foot 10, extending between the top and bottom sides.

The positioning foot 10 may be connected to the fastener driving tool 12 with a coupling 38. In one embodiment, the coupling 38 may include a coupling arm extending between the fastener driving tool 12 and the positioning foot 10. The coupling 38 may be formed integrally with either the tool 12 or the positioning foot 10 and secured to the other. Alternatively, the coupling 38 may be a separate component secured to both the tool 12 and the positioning foot 10. As another alternative, the coupling 38 may be formed integrally with both the positioning foot 10 and tool 12. The coupling 38 may be secured to the tool 12 and/or positioning foot 10, for example, by a clamp, weld, interference fit, adhesive, screws, bolts, pins, interlocking connection and the like. The coupling 38 is configured to secure the positioning foot 10 to the tool 12 at a desired angle relative to the drive axis ‘A’.

In one embodiment, the fastener driving tool 12 may be a powered screw driver and the fasteners 18 may be screws. The nosepiece 36 of the tool 12 may include the driving element or fastener driving arm (not shown). The driving element or fastening driving arm is extendable, retractable and/or rotatable on or along the drive axis ‘A’, to drive the fastener 20 through the clip 50 and into the work piece 54.

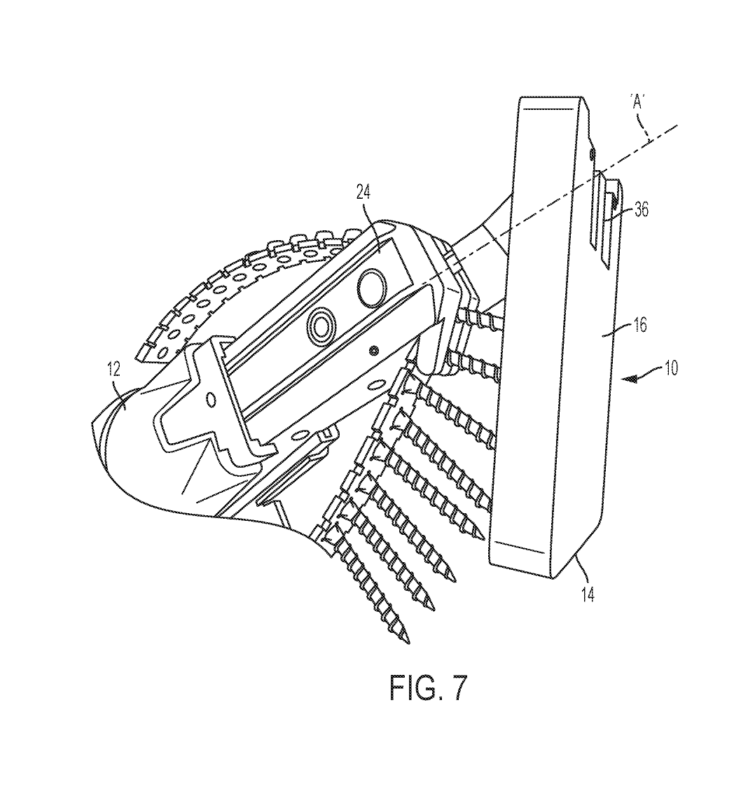

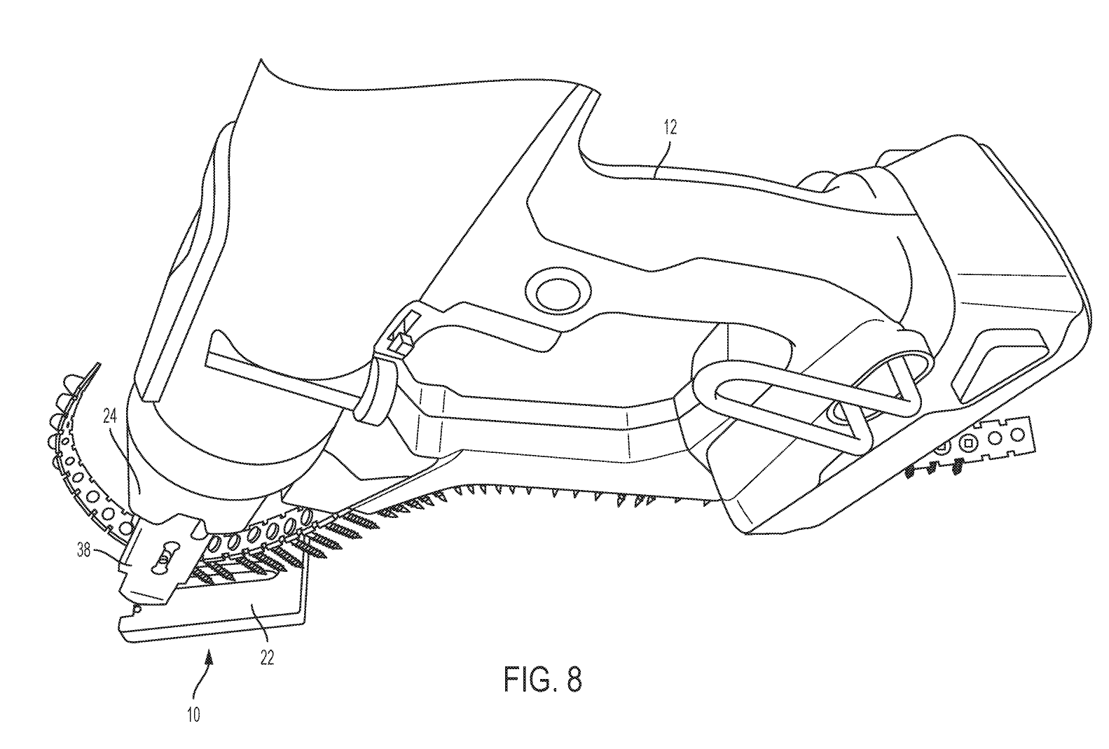

FIG. 8 is a perspective view of the positioning foot 10 together with the fastener driving tool 12 according to an embodiment described herein. Referring to FIGS. 1-8, in use, the positioning foot 10 may be secured to the fastener driving tool 12 via the coupling 38. The positioning foot 10 may then be positioned relative to a work piece such that the work piece engaging surface 16 is substantially flush with the work piece. The fastener driving tool 12 may be maintained at a desired angle relative to the work piece by way of the positioning foot 10 and coupling 38, while the operator holds the tool 12. That is, while the operator holds or supports the tool 12, the desired angle of the drive axis ‘A’ relative to the work piece may be maintained by way of the abutting relationship between the positioning foot 10 and the work piece. The nosepiece 24 of the tool 12 receives a fastener 20 from the fastener supply. A portion of the fastener 20 may pass through the fastener travel groove 16 on the tool-facing side 22 of the positioning foot 10 when moving to the nosepiece 24. The tool 12 may be actuated to drive the fastener 20 along the drive axis ‘A’ into the clip 50 and the work piece at the desired angle.

FIGS. 9-11 show an example of the clip 50 that may be used in conjunction with the positioning foot 10 and the fastener driving tool of the embodiments described above. FIG. 11 shows an example of the clip 50 positioned relative to the work piece 54 and the structural members 52. Examples of the clip 50 suitable for use together with the positioning foot 10 and fastener driving tool described herein include the clip disclosed in U.S. Pat. No. 8,011,153, issued to Orchard, which is incorporated herein by reference in its entirety.

Referring to FIGS. 9 and 10, the clip may include, for example, a central lower base 56, a central upper base 58, a pair of spaced legs 60 and a pair of spaced arms 62. In one embodiment, the central lower base 56 and the pair of spaced legs 60 extend substantially in one plane, and the central upper base 58 and the pair of spaced arms 62 extend substantially in another plane, spaced from the one plane. A pair of spaced apart first webs 66 extends between and connects each arm 62 to a respective leg 60, and a central second web 68 extends between and connects the central lower base 56 to the central upper base 58. As shown in FIG. 10, the pair of first webs 66 may be spaced from the second web 68 in a length direction.

Referring to FIG. 11, the clip 50 may be fastened to an underlying support member or work piece 54, such as a substrate or a joist, for example. The fastener 20 may be received through clip 50 at the desired angle and into the work piece 54 to secure the clip to the work piece. The structural member 52, for example, a deck board, may then be positioned relative to the clip. In one example, the structural member 52 may include an end slot 64 configured to receive the central upper base 58 or the pair of spaced arms 62. The central lower base 56 or pair of spaced legs 60 may be received under the structural members 52.

In use with the positioning foot 10, according to one example, the clip 50 may positioned at the clip attaching section 18. The pair of spaced arms 62 extend over a portion of the tool-facing surface 22. In one embodiment, the detents 30 may be received in corresponding detent recesses (not shown) form on an underside of the spaced arms 62. The central lower base 56 may be received in the recess 36 of the positioning foot 10. The first web sections 66 may be disposed within respective notches 24 and, in one embodiment, may abut the positioning foot.

With the clip 50 positioned at the clip attaching section 18, the fastener driving tool 12 may drive the fastener 20 into and through the clip 50, and into the work piece 54. The clip 50 and the positioning foot 10 may be separated after the clip 50 is secured to the work piece 54 by moving the tool 12 and the positioning foot 10 away from the secured clip 50, to overcome a holding force of the detents 30. The detents 30 may be urged into the positioning foot 10 to disengage from the clip 50 while the tool 12 and positioning foot 10 are removed from the clip 50.

It is understood the clip 50 is described herein for the purposes of example, and the fastener driving tool 12 and positioning foot 10 are not limited for use only with the clip 50 described herein. Different clip structures having features similar to those of the clip 50 for engaging the clip attaching section 18 may be used. Alternatively, the clip attaching section 18 may be formed having a different configuration of notches 28, detents 30, and/or recess 36 for accommodating clips having different configurations.

In the embodiments above, an operator may operate the fastener driving tool 12, with the positioning foot 10, to fasten a clip to a work piece by positioning the clip on the positioning foot 10, holding the positioning foot 10 against the work piece 54, and actuating the driving arm of the tool 12 to drive the fastener 20 through the clip and into the work piece. Accordingly, the operator may quickly position the clip relative to the tool and the work piece and drive the fastener through the clip and into the work piece, at a consistent angle, without individually measuring each fastening operation.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular. In addition, directional terminology that may be used in this disclosure, such as “upper,” “top,” “lower,” “bottom,” “above,” “below,” “front,” and/or “rear,” or other similar terminology, is used only to describe relative positions and spatial relationships of certain features in one embodiment, and does not limit the present invention to a particular spatial orientation.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A positioning foot for a fastener driving tool comprising:
a base having a tool-facing surface and a work piece engaging surface opposite to the tool-facing surface; and
a clip attaching section at a first end of the base, the clip attaching section comprising a pair of notches configured to receive corresponding portions of a clip to position the clip on the base.

2. The positioning foot of the claim 1, further comprising a fastener travel groove formed in the tool-facing side.

3. The positioning foot of claim 2, wherein the pair of notches are positioned on opposite sides of the groove.

4. The positioning foot of claim 1, wherein clip attaching section further comprises a recess formed in the work piece engaging surface.

5. The positioning foot of claim 1, where the clip attaching section further comprises a detent for releasably engaging the clip.

6. The positioning foot of claim 5, wherein the detent is one or more spring loaded ball detents configured to selectively project outward from the base to engage the clip.

7. The positioning foot of claim 5, wherein the detent is disposed at the tool-facing surface.

8. The positioning foot of claim 2, further comprising a guide ring aligned with the fastener travel groove.

9. The positioning foot of claim 1, wherein the work piece engaging surface is substantially planar.

10. A fastener driving tool comprising:
a body having a nosepiece configured to drive a fastener along a drive axis; and
a positioning foot secured to the nosepiece, the positioning foot comprising:
a base having a tool-facing side and a work piece engaging surface opposite to the tool-facing surface; and
a clip attaching section at a first end of the base, the clip attaching section comprising a pair of notches configured to receive corresponding portions of a clip to position the clip on the base.

11. The fastener driving tool of claim 10, wherein the tool is a powered screw driver.

12. The fastener driving tool of claim 10, wherein the clip attaching section further comprises a recess formed in the work piece engaging surface configured to receive a portion of the clip.

13. The fastener driving tool of claim 10, wherein the clip attaching section further comprises a detent for releasably engaging the clip.

14. The fastener driving tool of claim 13, wherein the detent is one or more spring loaded ball detents configured to selectively project outward from the base to engage the clip.

15. The fastener driving tool of claim 13, wherein the detent is disposed at the tool-facing surface.
